(19) United States
(12) Patent Application Publication
(10) Pub. No.: US 2016/0348490 A1
(43) Pub. Date: Dec. 1, 2016

(54) SUBSEA PROCESSING

(71) Applicant: STATOIL PETROLEUM AS, Stavanger (NO)

(72) Inventors: Henning HOLM, Oslo (NO); William BAKKE, Stabekk (NO); Tor Arne GUNNERØD, Tananger (NO)

(73) Assignee: STATOIL PETROLEUM AS, Stavanger (NO)

(21) Appl. No.: 15/116,718

(22) PCT Filed: Feb. 5, 2015
(86) PCT No.: PCT/EP2015/052424

§ 371 Date: Aug. 4, 2016

(30) Foreign Application Priority Data
Feb. 5, 2014 (GB) 1401997.0

(51) Int. Cl. E21B 43/36; B01D 19/00

(52) U.S. Cl. CPC E21B 43/36; B01D 19/0042

(57) ABSTRACT

There is described subsea apparatus and a method for processing fluid from a well. In an embodiment, a pipeline (6) may be arranged to carry the multiphase fluid containing liquid and gas from the well. An outlet (10) extending through a wall of the pipeline may let gas out of the pipeline from said region and through the outlet to separate said gas and liquid. A compressor may be connected to the outlet to compress the separated gas. The separated liquid and the compressed gas may be combined. Separated liquid may be conveyed along a sloping portion of the pipe to a low point in the seabed terrain, and may be conveyed to a pump for boosting the flow of liquid. The pump may be located in an excavated hole or glory hole below the seabed.

### FIELD OF THE INVENTION

The present invention relates to subsea processing of fluid from a well.

### BACKGROUND

In well production, for example in the oil and gas production industry, it can be necessary to compress fluid from a well in order to ensure that sufficient levels of fluid are produced. Where wells are located subsea and remote distances from other facilities, it can be desirable to compress the well stream to help transport well stream fluids onward to a downstream facility, for example at the surface for example offshore or onshore.

For this purpose, it has been proposed to install compressors subsea near the well head to compress the fluid from the well, in particular the gas phase.

The fluid from the well may be multiphase, containing gas and liquid phases. The amount of liquid and gas, and the nature of the flow, may fluctuate.

Prior proposed arrangements may incorporate some processing of the well fluid upstream of such compressors in order to meet compressor operational requirements. Such processing equipment may include coolers and scrubbers which may be used to reduce liquid content of the gas so that the gas meets the required specification. Liquid that is separated from the gas may be conveyed downstream separately of the gas, for example with the assistance of a liquid pump.

In addition, it has been suggested to provide the compressor in a compressor station on the seabed. Such a compressor station may comprise a robust marine frame which houses and supports the compressor and the processing components (pump, scrubber and/or cooler).

The compressor station configuration facilitates access to the compressor and other processing components. The compressor and processing components may each be provided in removable modules in the frame to facilitate replacement and/or repair.

### SUMMARY OF THE INVENTION

The inventors have recognised that a challenge with the conventionally proposed compression stations described above is that a significant increase in size and complexity may be required in order to cope with a large fluid output from a well. Relatively large maintenance costs can then be expected in the operational phase, and total availability to the compression station may suffer due to the complexity.

Various aspects of the invention are provided as set out in the claims appended hereto.

Each and any of these aspects may include further features, as set out in the claims appended hereto or in the present description.

It will be appreciated that features mentioned in relation to any of the above aspects, whether in the claims or in the description, may be combined with each other and between the different aspects.

### DESCRIPTION OF THE INVENTION

There will now be described, by way of example only, embodiments of the invention with reference to the accompanying drawings, in which:

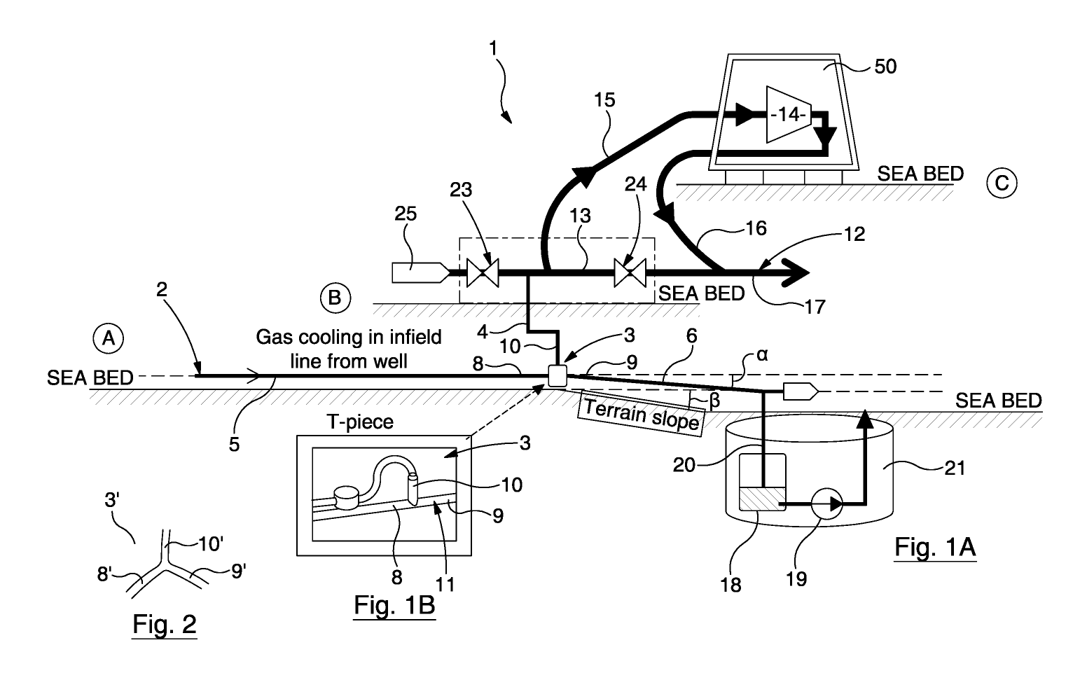

FIG. 1A is a schematic representation of apparatus for processing fluid from a well;

FIG. 1B is a representation of a T-shaped pipe tee of FIG. 1A;

FIG. 2 is a representation of a Y-shaped pipe tee for apparatus for processing fluid;

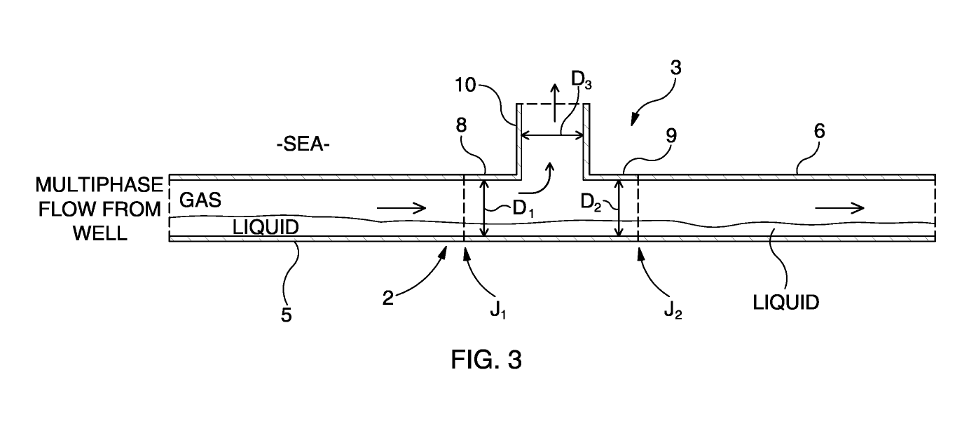

FIG. 3 is a cross-sectional representation of the T-shaped tee of FIGS. 1A and 1B;

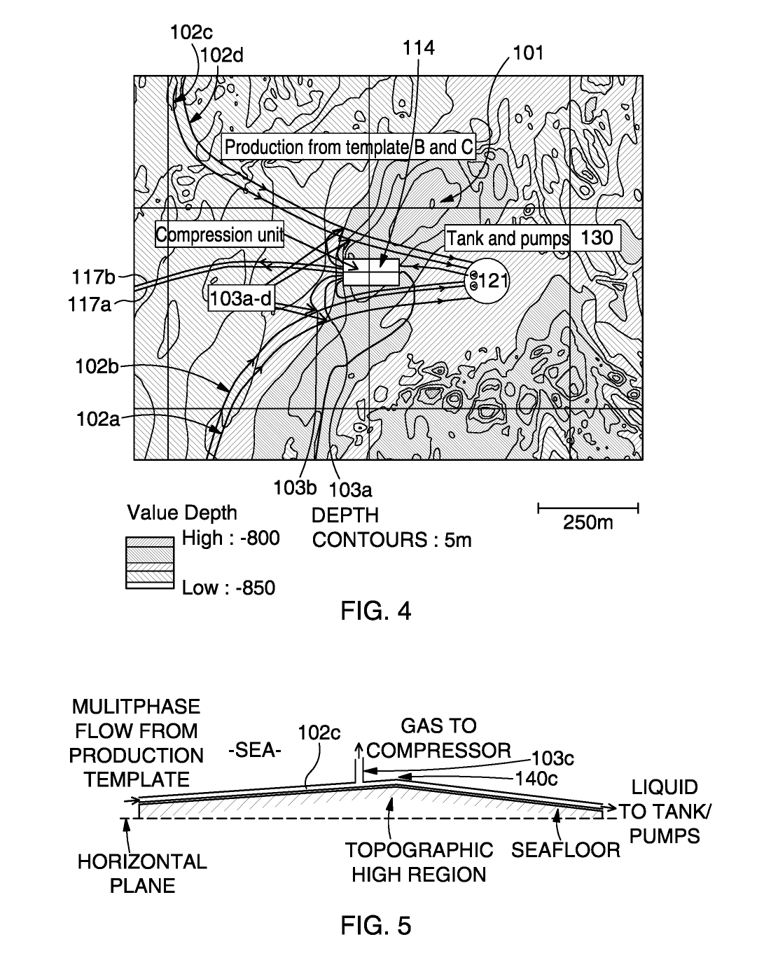

FIG. 4 is map view representation of apparatus arranged on the seabed showing seabed topography according to an embodiment of the invention;

FIG. 5 is a side cross sectional representation of a pipeline of the apparatus of FIG. 4;

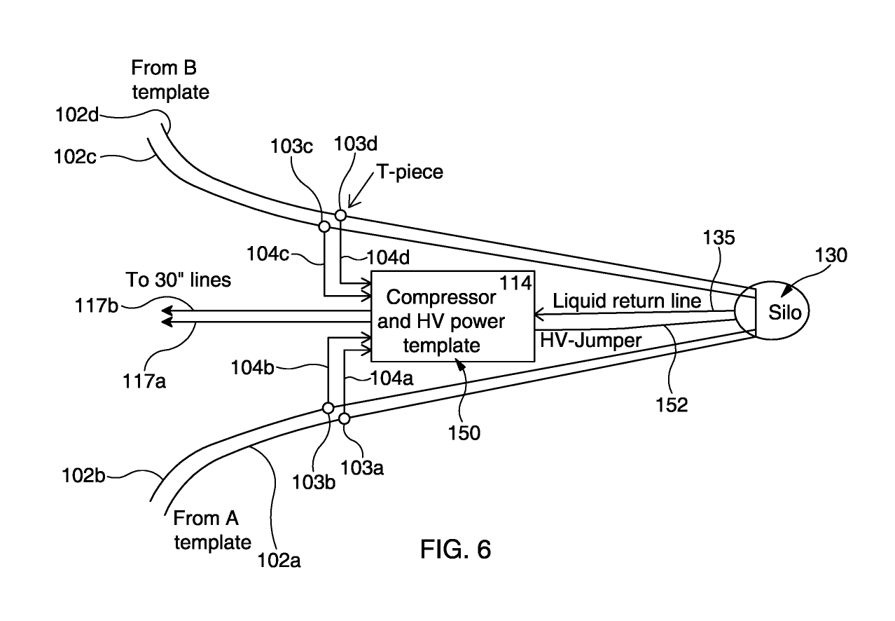

FIG. 6 is a plan view representation of the apparatus of FIGS. 4 and 5;

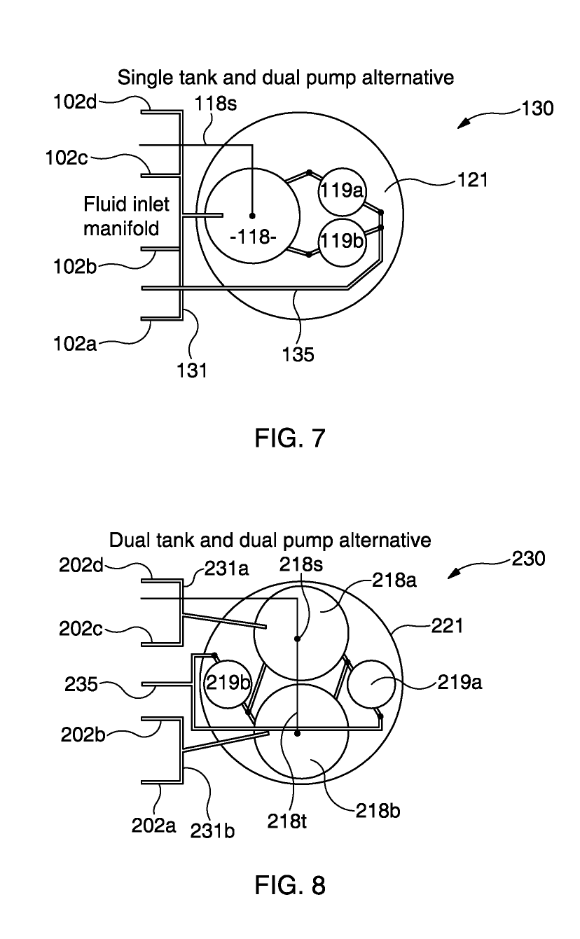

FIG. 7 is a plan view representation of a liquid handling arrangement comprising a tank and two pumps for use in the apparatus of any of FIGS. 1 to 6;

FIG. 8 is a plan view representation of another liquid handling arrangement comprising two tanks and two pumps for use in the apparatus of any of FIGS. 1 to 6;

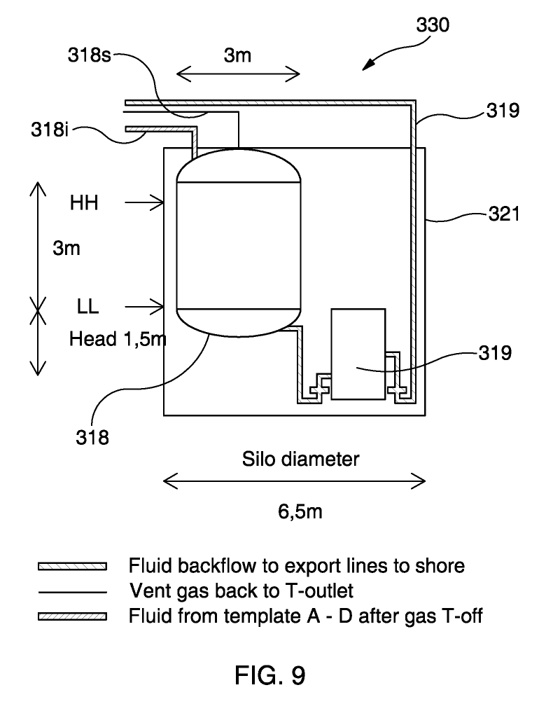

FIG. 9 is a side view representation of another liquid handling arrangement comprising a tank and a pump for use in the apparatus of any of FIGS. 1 to 6; and

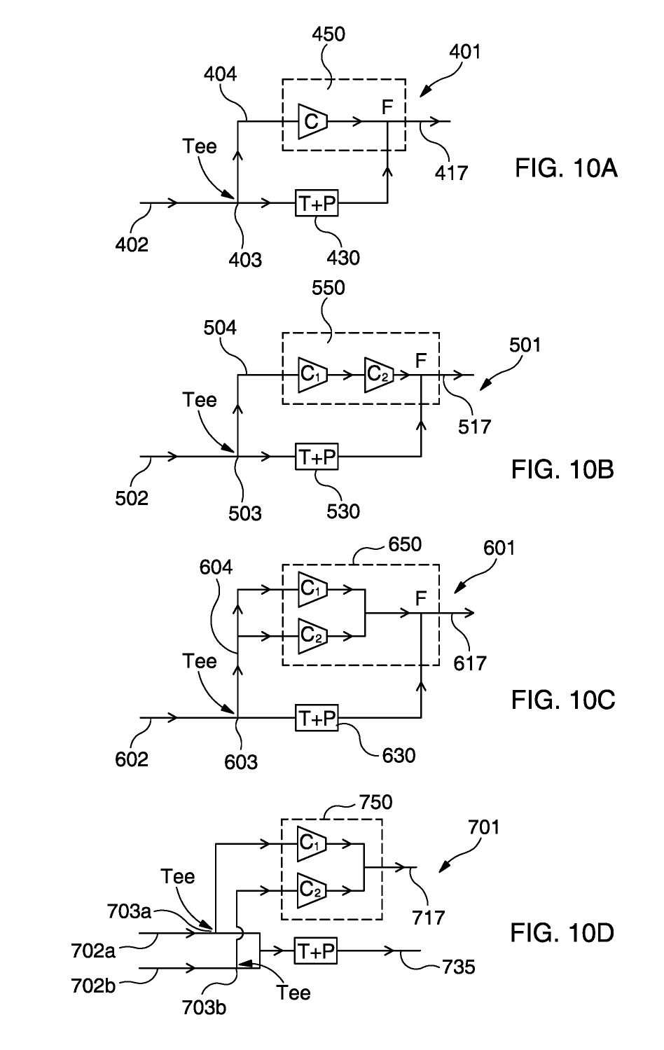

FIGS. 10A to 10D are schematic representations of apparatus for subsea processing of fluid from a well.

In FIG. 1A, the apparatus 1 for processing fluid from a well is exemplified as distributed between different seabed locations A, B and C.

As seen in FIG. 1A, the apparatus 1 includes a pipeline 2 which contains a flow of fluid, e.g. hydrocarbon fluid, from a well. The fluid contains liquid and gas. In proximity to a trunk line 17, a pipe tee is arranged to provide an outlet 3 through the wall of the pipeline 2. The outlet is arranged to let gas out of the pipeline 2 to separate the gas from the liquid and produce separated gas and separate liquid.

The pipe tee 3 can be a three-pronged or three-way tubular tee, for example a T or Y shaped tee. An example of a T-shaped tee is seen in close up in the inset FIG. 1B. The tee has first and second tubular arms 8, 9 and a tubular stem 10. The first and second arms 8, 9 are connected respectively to first and second portions 5, 6 of the pipeline 2. The arms 8, 9 define a fluid flow path extending through the first portion 5, the pipe tee 3, and the second portion 6 of the pipeline 2. FIG. 2 shows an example of a Y-shaped tee 3′, comprising tubular first and second arms 8′, 9′ connected to a tubular stem 10′.

The first and second arms 8, 9 of the pipe tee may together define a tubular body 11 forming a section of the pipeline 2. The outlet may thus be formed through the wall in the tubular body. The stem 10 is connected to and extends radially outwardly from the tubular body 11.

The apparatus has a gas pipe 4 which is connected to the stem 10 and receives gas from the pipeline through the aperture. The stem 10 defines a path for gas between the inside of the pipeline 2 and the gas pipe 4.

As seen in FIG. 1, the tee may in practice be used in an upside-down “T” configuration, with the stem 10 arranged vertically to provide an outlet for gas from a region inside the pipe adjacent to the pipe wall, in an upper part of the pipe wall.

The multiphase fluid may typically be carried inside the pipeline in a stratified flow, in which liquid, e.g. oil, flows along a base of the pipe with gas, e.g. hydrocarbon gas, thereabove. The fluid may typically include hydrocarbon gas and hydrocarbon liquid such as oil.

During operation, a flow of the multiphase fluid passes through the first portion 6, and enters the tee. Gas escapes naturally up through the stem of the tee into the gas pipe 4 (as “separated gas”), whilst liquid from the multiphase fluid remains inside the pipeline, passes the tee and enters into the second portion 6 of the pipeline (as “separated liquid”). In this way, gas is tapped off automatically, as the multiphase flow is passed along the pipeline as a result the gas and liquid contents are separated.

The pipeline 2 may have an internal diameter of up to around 30 inches, in some embodiments between 10 and 20 inches, and in other examples 14 inches.

In FIG. 3, the pipe tee 3 can be seen in closer detail and in cross-section. The pipeline 2 is a standard pipeline for placing on the seabed with outer surface in direct contact with the surrounding sea. This may for example be a typical steel pipeline. The pipeline has an outlet or opening in the wall for letting out gas. In this case, the tubular portion or stem 10 extends perpendicularly and vertically outwards from the pipeline wall, but it will be noted that the stem could be arranged at acute angles to the pipeline 2. The tee may be provided with the same dimensions and materials of the pipeline otherwise, e.g. constructed from standard and readily available pipe sections and fittings. The tee 3 may be constructed, for example be preformed prior to installation in the pipeline, by forming an aperture in the wall of a first pipe section and joining the end of a first pipe section to the wall of the second pipe section, for example by welding. The pipe tee 3 may then be connected to the pipe section 5 from the well, e.g. by end to end pipe joins at point J1 between the pipe section 5 and arm 8, and at point J2 between arm 8 and pipe section 6.

Internal diameters D1, D2 of the first and second arms 8, 9 of the tee as shown in FIG. 3 are equal to respective internal diameters of the first and second pipe portions 5, 6 to which the first and second arms are connected. In this way, the pipeline 2 may have a constant internal diameter and define a continuous tube between the first and second portions across the tee 3. This may minimise disruption to the flow inside the pipeline across the tee between the first and second portions 5, 6. The stem o 10 has a diameter D3 that is the same as the diameters D1 and D2 of the arms of the tee.

However, in general it will be noted that in other variants, one or the other of the arms 8, 9 may have a greater or smaller internal diameter than that of the other. The stem 10 may have a different internal diameter to, for example smaller or greater than, that of either of the arms 8, 9. Furthermore, it can be noted that internal diameters of the tee and/or of the pipe sections at the joining points to the tee could be greater or less than the diameter of the pipe section 5 further upstream and/or pipe section 6 further downstream. An increased size of the main pipe and tee reduces gas and liquid velocity and allows more droplets to settle before the tee. Decreased size can increase gas and liquid velocity, and increased droplet inertia could give better separation. Using the same standard diameters in all parts arms 8,9 and stem 10 and sections 5 and 6 can be simpler and less costly.

It will be appreciated that the arms of the tee may be defined by tubular sections of the first and second portions 5, 6 of the pipeline, whilst the stem 10 may be defined by a section of the gas pipe 4.

In other embodiments, a plurality of pipe tees may be provided on the pipeline to separate the gas.

The separated gas is passed through the gas pipe 4 to section 13 of a trunk pipeline 12. The trunk line is provided with valves 23, 24, which are shut. The gas is then conveyed from the trunk line section 13 through a gas In-pipe 15 to a compressor 14 which compresses the gas. The compressed gas is conveyed from the compressor 14 through a gas Out-pipe 16 to the trunk line, through which the compressed gas is transported to a downstream facility, e.g. an onshore or topside facility for further processing.

In other embodiments, the gas may by pass the section 13 to enter the compressor 14 directly. However, the arrangement shown can be convenient for directing gas to the compressor when switching production from a first, natural flow production, phase to a second, compression, phase in which the compressor is used. In the natural phase, valve 24 is open and gas from the outlet is directed through the valve along the trunk line. In the compression phase, the valves 23, 24 are used to direct gas to the compressor, as shown in the figure. The trunk line has a pig launcher/receiver 25 for launching or receiving pigs through the trunk line through valves 24 and 25 when required. The gas pipe 4 and In pipe 15 is typically non-piggable. A hydrate inhibitor may then be inserted in the gas flow in these pipes 4 and 15 to prevent possible blockage.

The trunk pipeline 12 may have an internal diameter of up to around 50 inches, in some embodiments for example between 20 and 40 inches, and in particular examples 30 inches.

The separated liquid passes through the second pipeline portion 6 and is conveyed via a tank 18 and pump 19 in a liquid handling arrangement to a downstream facility (not shown). The liquid may be combined with the compressed gas in the trunk line 17, or may be carried separately of the compressed gas to the downstream facility.

The second portion 6 of the pipeline is sloped downwards, in the downstream direction, to help move the separated liquid under the force of gravity along the pipeline. The length and slope of the second portion 6 is selected so as to be able to absorb liquid slugs in the multiphase flow such that the slug flow effects on the processing system are avoided.

In practice, the portion 6 of the pipeline 2 downstream of the tee may have a length in the range of a few tens of metres to several kilometres and may define a slope inclined downwards toward the tank and pump, in the downstream direction, at an angle from horizontal of typically 0.5 degrees or greater.

The second portion of the pipeline may extend over a region of the seafloor with a slope in terrain. The natural changes in the seafloor topography may be utilised to provide the necessary slope of the pipeline, downstream of the tee. For example, the pipe may lie on a sloping part of the seabed. The portion 6 may slope away from the tee, and from the well, and follow along a slope of the seabed downwards into a topographic low region in the seabed, toward the downstream tank and liquid pump. The tee may be arranged at a relative high point of the seabed. The pipeline may be arranged such that the second portion 6 has a slope greater than the first portion. The first portion 5 of the pipeline may be arranged horizontally. Similarly, the tubular body section of the pipeline defined by the arms 8, 9 of the tee may be arranged horizontally, i.e. with a longitudinal through-axis in a horizontal plane.

The end of the pipeline may be provided with a pipe section 20 connecting the pipeline 2 to the tank 18. The tank 18 is provided in a hole 21, for example an excavation, silo or glory hole or caisson, extending into the subsurface from the seabed. The pump 19 is connected to the tank and is arranged to receive liquid from the tank on a continuous basis. The pump is also provided in the excavation or glory hole along with the tank. The tank receives and contains separated liquid, and may be dimensioned so as to help absorb variations of liquid content in the multiphase flow. For example, if there is a large variation of liquid content of the fluid from the well, the tank may be sized so that there is little impact on the liquid level within the tank. The tank has an outlet for liquid from the tank. The tank and/or outlet may be arranged to let liquid out of the pump at a consistent rate over time, to the pump. The pump speed may be controllable to control the rate of liquid out of the tank. For example, the pump speed may be controlled or varied based on the level of liquid in the tank. From the pump, the liquid is driven out of the hole along a liquid transport pipe.

By directing the liquid into the hole location below the seabed the influence of the force of gravity to drive liquid flow is enhanced; a difference in potential energy is generated. This facilitates onward transport of liquid, and reduces pump requirements.

In other embodiments, the pump and tank may be located at the seabed for example in a topographic depression. In such a case, the gradient of the slope of the second pipe portion 6 may provide sufficient height above the pump that a significant gravity component contributes to driving the liquid flow.

It can be noted that some gas may be present or be released from the flow of liquid in the tank or in the sloping second portion 6 of the pipeline 2 downstream of the tee. Such gas will travel against the flow of liquid in the vertical pipe 20 and second portion 6, and escape through the outlet of the tee through the wall of the pipeline, into the gas pipe 4. The liquid in the tank provides in effect a dead-end for gas. The only outlet for gas to escape is through the pipe tee 3.

In practice, the hole 21 may be provided with a receptacle or tubular lining to define the necessary space therein for receiving the tank 18 and pump 19. The hole is typically open to the sea. Other processing components may also be provided in the hole 21.

The tee in this case is positioned a substantial distance away from the well, such that the pipeline portion 5 upstream of the tee acts to cool the fluid in the pipeline. The multiphase fluid from the well may at an upstream location close to the well head, have a temperature of around 60-120 degrees Celsius. The temperature of the seawater surrounding the pipeline at the seabed may be around 0 to 4 degrees. The pipeline 2 is exposed directly to the sea on one side with the multiphase flow from the well contained inside the pipeline on the opposite side of the pipeline wall. The fluid inside the pipe is in heat exchange relationship with the sea across the wall of the pipeline 2. As a result, heat is transferred from the fluid across the wall of the pipeline to the surrounding sea causing the fluid inside the pipeline to cool. At the pipe tee, the fluid in the pipeline may have been cooled as a result of its transport through the pipe to a temperature of around 0 to 10 degrees Celsius. Preferably, the length of this section is such that the temperature of the fluid from the well is cooled down to the temperature of the surrounding sea in the section 5. By cooling the fluid in the pipe, condensed liquid may be produced from the gas, contributing to reducing liquid content in the gas. In order to provide sufficient cooling, the pipe tee may be arranged at least 5 km from the well. Thus, the pipeline portion 5 may have a length of at least 5 km.

However, if the length of pipeline is insufficient or the fluid in the pipeline is not cooled to the desired temperature, then a dedicated cooler may be provided upstream of the tee that provides higher rates the cooling of the multiphase fluid. An active cooler that could be readily adapted for this purpose is described in the publication WO2013/023948. Although this publication describes the active cooler in relation to use on a gas stream, it could be applied herein to the multiphase flow upstream of the tee 3. An active cooling arrangement used along the upstream pipeline section 5 could involve splitting the multiphase flow and directing it through multiple cooling tubes over limited distance, and then circulating seawater in and around the outer surfaces of the cooling tubes such that the seawater near the outer surfaces of the tubes is replenished with fresh, cold seawater that enhances the cooling and heat exchange effect across the cooling tubes. An impeller may be used to circulate seawater, and/or guide plates may be used to help guide the seawater past the cooling tubes. Alternatively, active circulation may be performed directly to the pipeline section without splitting into cooling tubes. This could be done for example using an impeller to direct flow through an open annulus formed around the pipeline over a limited distance.

Other enhanced cooling arrangements that could be applied to the multiphase flow upstream of the tee could include the coolers described in the patent publications WO2013/004277 and WO2013/131574.

In other embodiments, a second pipeline, and optionally further pipelines, could be provided in addition to pipeline 2 and arranged similarly. Such a second (or each further pipeline) may be provided with a tee through a wall of the second pipeline to separate gas from the liquid, and separated gas may be supplied to a compressor and be compressed. Multiple compressors may be used. The compressed gas from each such pipeline may be supplied into a single trunk line 17. The trunk line may then act as a common transport pipeline for transporting separated and compressed gas from the different pipelines. Separated liquid from each pipeline may be conveyed to a pump located in a single excavation, silo caisson or glory hole 21. The hole 21 may then act as a common hole housing equipment for processing liquid from the different pipelines. The liquid from different pipes may be conveyed out of the glory hole in a common liquid transport pipe. A plurality of tanks and/or pumps may be arranged, for example as outlined above in relation to the pipeline 2, to receive and drive the flow of the separated liquid from the pipelines.

In FIG. 4, there is shown an example of how apparatus such as that described above, for processing well fluid subsea might be arranged on the seabed, make use of the seafloor topography or bathymetry. In this example, apparatus for processing the fluid from a well is referenced by numeral 101. Features of the apparatus 101 have the same reference numerals as like features of the apparatus 1 described further above, except incremented by one hundred.

Pipelines 102a-d from subsea well heads terminate at a liquid handling arrangement 130. The trajectories of the pipelines 102a-d follow the seafloor topography. FIG. 5 shows as an example the trajectory of pipeline 102c near the compression unit 114. The pipeline 102c climbs, in the flow direction (left to right in FIG. 5) to a topographic high region on the seabed, and then descends from the high region toward the liquid handling arrangement. The pipeline is supported on the seabed, for example in direct contact with seabed mud or supported by ballast or other supports, although it is sought to minimise extra constructions to support and preferably use the natural topography. Thus, in this example the pipeline trajectory corresponds with the seabed topography, and therefore has a high point corresponding with the topographic high region. The pipe tee 103c is preferably arranged on the upward inclined portion, just before the peak 140c. The compressor 114 and pipe tees 103a-d are arranged nearby and close to each other. As seen in FIG. 4, the compressor is at a relative topographic high relative to its surroundings, and is positioned approximately equidistant between the tees of different pipelines 102a-d. Preferably, the incline of the pipeline to the pipeline peak 140c and decline between the peak 140c and the liquid handling arrangement 130 is monotonic. Preferably there are no undulations or disruptions in the sloping sections of the pipeline, in particular the section sloping downwards from the tee or topographic peak toward liquid handling arrangement. This helps to ensure a stable flow and effective separation. The liquid handling arrangement is provided at a topographic low or hollow region on the seabed.

The apparatus 101 can be seen more clearly in FIG. 6. In use, multiphase fluid is carried through the respective pipelines 102a-d towards respective pipe tees 103a-d, which may have a form as described in the examples above. The pipe tee defines an opening in the upper wall of the pipeline for venting gas from the pipeline into a gas pipe 104a-d, thus separating the gas from the liquid. The gas is carried in the gas pipes 104a-d and is supplied into at least one compressor 114 provided on a subsea compression template 150, which compresses the supplied gas. The compression template provides a seabed support for the compressor 114.

Downstream of the tees 103a-d, separated liquid in the pipeline 102b flows along the base of the pipeline and is collected in at least one tank in the liquid handling arrangement 103. The pipeline is preferably oversized so that the flow actually comprises a trickling flow of liquid in the base of the pipe. The length and downward slope of the pipeline between the tee and the arrangement 103 is such that liquid slugs are absorbed and the flow is stable. This can also help to allow any residual gas in the liquid back to the tee, improving the separation.

The liquid from the tank is then pumped using a pump in the arrangement 103, through a liquid pipe 135, and is combined with the compressed gas from the compressor 114, at the compressor template 150. The combined gas and liquid are then transported onward downstream in trunk lines 117a and 117b to at least one downstream processing facility.

It can be noted that in this example, the subsea compression template 150 includes high voltage power unit, e.g. module, for providing the compressor with power. An HV-jumper cable is provided between the power unit on the template 150 and the liquid handling arrangement. Power may therefore be supplied to the pump and any other equipment of the handling arrangement 130 through the jumper cable 152 from the power unit.

Turning now to FIG. 7, an example of a liquid handling arrangement 130 described above is shown. The liquid handling arrangement 130 has a tank 118 and two liquid pumps 119a, 119b. The pumps are connected to the tank 118 so as to be able to receive liquid from the tank and pump it onwards through the liquid pipe 135. The use of two pumps provides redundancy in the system. If one of the pumps fails, the other can act as a back-up for the other. Accordingly, each of the pumps may have a capacity to handle liquid incoming to the tank as necessary to continue the processing of the fluid from the well at the seabed at full capacity. Thus, the pumps may be operated individually, one at a time, or in other embodiments both pumps may be activated and used to pump fluid, in which case the individual pumps can be run at lower rates.

As can also be seen in FIG. 7, the handling arrangement 130 has an inlet manifold arranged to connect the ends of the pipelines 102a-d with an inlet to the tank 118. In this way, the liquid from the pipelines can be brought into a common flow that enters the tank 118. The tank is designed such that there is a body of liquid received in the tank that is relatively settled and is continuously present. The level of the body of liquid in the tank may be monitored and maintained by increasing or decreasing the speed of the pumps. A sensor 118 for measuring the liquid level may be provided on the tank for monitoring the amount of liquid. This measurement may also be used to detect whether the liquid is being pumped as intended.

In this example, the tank and pumps are provided in a hole or silo 121 that extends below the seabed.

FIG. 8 shows an alternative liquid handling arrangement 230, which equally may be employed with any of the embodiments described. Like features to those described in relation to the apparatus 1 have the same reference numerals but incremented by two hundred, and in relation to like features described in relation to FIG. 7 the same numerals but incremented by one hundred.

In this case, the liquid handling arrangement 230 has two tanks 218a, 218b and two pumps 219a, 219b provided in a hole 221 extending into the subsurface beneath the seabed. The ends of the pipelines 202c and 202d are connected to an inlet of the first tank 218a through a first manifold 213a, whilst the ends of the of the pipelines 202a and 202b are connected to an inlet of the second tank 218b through a second manifold 231b. Pumps 219a and 219b are connected to the respective tanks 218a and 218b so as to receive liquid from the tanks and operate to pump the liquid into and downstream along the liquid pipe 235. The outlets from the two pumps are thus coupled to combine the liquid exiting from the pumps to form a single stream of liquid that is transported downstream, to for example, combine with the compressed gas from the compressor. This arrangement also provides a degree of redundancy in that production from the field can still continue via one of the pumps if the other fails or requires maintenance.

FIG. 9 illustrates a further liquid handling arrangement 330 that may be used with any of the embodiments above, comprising one tank and one pump provided in a hole or silo in the subsurface below the seabed. The silo is lined to form a silo wall and has a base to allow equipment to be installed. The silo acts to shield the equipment from the surrounding subsurface. Like features to those described in relation to the apparatus 1 have the same reference numerals but incremented by three hundred, and in relation to like features described in relation to FIG. 7 or FIG. 8 the same numerals but incremented by two hundred or one hundred respectively.

The tank 318 receives liquid from one or more pipelines through an inlet 318i at an upper end of the tank. The pump 319 receives liquid from the tank, via an outlet at the lower end, and pumps the liquid out through a pump outlet 319x and into the liquid pipe for transport of liquid downstream. A sensor 318s for measuring and monitoring liquid levels in the tank is provided on the tank. The silo capacity is for example up to 20 m3, such as between 10 and 20 m3.

With further reference now to FIGS. 10A to 10D, different methods and apparatus for performing subsea processing of fluid from are described. Like features to those of the apparatus described above have the same reference numerals but incremented by multiples of one hundred.

In FIG. 10A, multiphase fluid comprising liquid and gas from a well is carried downstream in a pipeline 402 towards a pipe tee 403. At the tee, gas is separated from the liquid and supplied to the compressor C through a gas pipe 404, where it is compressed. The separated liquid is continues to travel along the pipeline to the tank and pump T+P. The liquid is then pumped and combined with the compressed gas at point F, producing combined fluid which is then transported to a downstream processing facility, e.g. onshore, via pipeline 417. The compression and the combining of liquid and compressed gas is performed on the subsea compression template 450. This configuration is akin to that of FIG. 4. The combining may be performed using a combiner at point F, which may include a nozzle arranged to inject the liquid into the compressed gas.

The FIG. 10B configuration is the same as that of FIG. 10A, except the compression is performed using two compressors C1 and C2 which are arranged in series. That is, the separated gas is supplied first to compressor C1, which compresses the gas. Compressed gas from C1 is then supplied to a second compressor C2, and further compressed, and the liquid from the tank and pump T+P is combined with the further compressed gas at point F. The use of a further compressor increases the compression capacity provided. The compression template 550 may be arranged such that in an initial stage of compression, only one compressor is used, e.g. C1. At a later stage of compression, a second compressor C2 may be installed on the existing template and connected to the compressor C1 and used as indicated. The template may thus be designed to allow installation of further compressors in series in stages.

The FIG. 10C configuration is another variant, which is basically the same as that of FIG. 10A, except that compression is performed using two compressors C1 and C2 which are arranged in parallel. In this variant, the separated gas is divided into two, e.g. through a manifold, such that first separated gas is supplied to and compressed by the first compressor C1, and second separated gas is supplied to and compressed by the second compressor C2. First and second compressed gas from the first and second compressors C1, C2 is combined and liquid is added into the combined gas at point F to produce combined gas and liquid which is transported to a downstream facility via pipeline 617.

FIG. 10D provides another variant wherein multiphase flow comprising liquid and gas is provided from two wells along two separate pipelines 702a,b toward respective pipe tee 703a,b at which separation of gas and liquid is performed in the manner described above. The separated gas from each pipeline is fed to respective compressors C1 and C2, which compresses the gas, in effect providing a plurality of compressor trains. The compressed gas from each is combined and supplied through a pipeline 717 to a downstream facility. The liquid is fed to the tank and pump, and pumped onwards downstream separately of the gas through pipeline 735, and without routing the liquid through the template 750. Any combination of liquid and gas would then be performed further downstream, rather than on the compression template.

Further embodiments are envisaged, in which two compressors are provided and the supply pipes and routing of gas into and out of the compressors are switchable e.g. using valves, to use the compressors optionally and/or selectably in parallel configuration or in series configuration, such as described above.

The compressor may be a wet gas or dry gas compressor. In the latter case, scrubbing of the separated gas may be needed.

The compression templates in the arrangements described above may support the compressor(s), manifolds for supply into and out of the compressors, and related equipment for operating the compressor such as automatic magnetic bearings AMB and associated control, variable speed drive (VSD) motor and controller, and power supply. Preferably, the templates do not have any gas scrubber, or any additional cooling devices to cool the incoming gas from the tee other than a standard inlet pipe.

In order to reduce compression template size, one option could be to provide the power supply on a separate subsea template, in effect removing it from the compression template. The dimensions of the compression template may then be controlled by the VSD. The height of the compression template may be reduce further by arranging the compressors horizontally, e.g with their rotational axis in a horizontal orientation.

Use of a pipe tee provides a simple way of tapping off gas from the pipeline to separate the gas and liquid without any other modification to the pipeline than providing an outlet in the wall of the pipe and connecting the gas pipe thereto. That is, the simple presence of an outlet through the wall in the upper portion of a pipe section removes the gas flowing adjacent to or against the wall inside the pipeline. There is minimal disturbance to the flow, such that the liquid may continue from pipe portion 5 into the pipe portion 6 as a stratified fluid. The flow path for fluid through the pipeline portions 5, 6 and the tee is a smooth, unobstructed and/or slowly changing flow path. The pipeline 2 can simply consist of basic standard pipeline sections and fittings. The walls of the pipeline and/or the tee, i.e. stem and arms, keep the surrounding sea out of the pipeline and/or tee. There is no need for any internal modification to the diameter or any arrangement to stimulate the fluid or liquid inside the pipe in proximity to the outlet aperture or tee.

The apparatus provides good separation efficiency through the outlet in the tee, to a level at which the gas exiting the pipeline at the tee is suitable for compression in a compressor. The fluid and gas is cooled in the upstream portion 5 sufficiently to condensate liquid from the gas such that no further cooling of the gas exiting the pipeline, e.g. in a scrubber, is required before the gas enters the compressor.

Testing indicates that a high 99% by volume separation efficiency can be achieved using the arrangement described. Thus, the separated gas at entry to the compressor may have a liquid content of less than 1% by volume, in particular for gas dominant multiphase fluids from the well.

The invention described has a number of advantages. It provides a simple and effective way of processing multiphase fluid from wells, in particular at a subsea hub where long distance pipelines from satellite wells meet for onward transport in large diameter common trunk lines, in particular where there are large capacity requirements. Subsea compression stations and modules can be reduced significantly in size and weight for a given capacity requirement and made less complex.

Accordingly, the technique may be more suitable for deployment and producing hydrocarbons in deep water. For example:
1) Routing liquid on a route which does not pass through the compression station for processing by a separate pump, reduces or eliminates the need for liquid handling tanks and pumps on the compression station;
2) The efficiency of separation of the tee is significant, and reduces or eliminates the need for further separation equipment or scrubbers upstream of the compressor; and
3) The use of the pipeline for cooling upstream, reduces or eliminates the need for further cooling equipment upstream of the compressor.

Other advantages may be apparent from reading the description.

It will be appreciated that the term “subsea” should be understood to include usage in land locked or partially land locked seas, such as lakes, fjords or estuarine channels, in addition to open seas and oceans whether containing salt water or fresh water, or mixtures thereof. The terms “seabed” and “seawater” have meanings accordingly.

Various modifications and improvements may be made without departing from the scope of the invention herein described.

1-74. (canceled)

75. A subsea apparatus for processing fluid from a well, the apparatus comprising:
a pipeline arranged to contain a flow of said fluid, said fluid comprising liquid and gas;
an outlet extending through a wall of said pipeline, said outlet arranged to let gas out of the pipeline through the outlet to separate said gas from said liquid and produce separated gas and separated liquid;
at least one compressor arranged to compress the separated gas; and
a cooler arranged upstream of the outlet to cool the fluid from the well.

76. A method of processing fluid from a well, the method comprising the steps of:
providing a pipeline subsea, said pipeline having an outlet through a wall;
containing a flow of said fluid inside the pipeline;
letting gas out of the pipeline through the outlet to separate said gas from said liquid to produce separated gas and separated liquid;
compressing said separated gas; and
cooling the fluid upstream of the outlet using a cooler.

77. A subsea apparatus for processing fluid from a well, the apparatus comprising:
a pipeline arranged to contain a flow of said fluid, said fluid comprising liquid and gas;
an outlet extending through a wall of said pipeline, said outlet arranged to let gas out of the pipeline through the outlet to separate said gas from said liquid and produce separated gas and separated liquid;
at least one compressor arranged to compress the separated gas; and
a combiner arranged to combine the separated liquid and the compressed gas.

78. The subsea apparatus as claimed in claim 77, further comprising an outlet pipe section which defines the outlet, and being arranged to extend outwards from an outer surface of the pipeline.

79. The subsea apparatus as claimed in claim 78, wherein the outlet pipe section is arranged at an angle to the outer surface of the pipeline, and wherein the outlet pipe section comprises a stem of a pipe tee.

80. The subsea apparatus as claimed in claim 79, wherein the pipe tee comprises a stem and first and second arms connected to and extending from the stem, the arms defining a tubular section of the pipeline and the stem defining said outlet for said gas, and wherein the stem is substantially perpendicular to the arms to define a T-shaped pipe tee.

81. The subsea apparatus as claimed in claim 77, wherein a portion of the pipeline downstream of said outlet is arranged to receive said separated liquid, and wherein said portion of the pipeline is sloped over at least part of its length, wherein said pipeline is arranged to be located at or on the seabed, and the sloped portion is arranged to slope in a downstream direction between a first point along the pipeline and a second point along the pipeline, and the seabed is lower at the second point than at the first point, and wherein at the second point, a topographic depression is present at the seabed.

82. The subsea apparatus as claimed in claim 81, wherein said tank is arranged upstream of said pump, and the pump is arranged to receive separated liquid from the tank.

83. The subsea apparatus as claimed in claim 82, wherein said pump and/or tank is arranged at or adjacent to said second point.

84. The subsea apparatus as claimed in claim 82, wherein said pump and/or tank is arranged to be located in a structure formed at the seabed.

85. The subsea apparatus as claimed in claim 77, further comprising an enhanced cooling arrangement arranged upstream of the outlet to cool the fluid from the well.

86. The subsea apparatus as claimed in claim 85, wherein the cooling arrangement comprises an active cooler arranged to circulate seawater adjacent the pipeline.

87. The subsea apparatus as claimed in claim 77, said outlet being positioned a distance along the pipeline of at least 5 km from the well.

88. A method of processing fluid from a well, the method comprising the steps of:
providing a pipeline subsea, said pipeline having an outlet through a wall;
containing a flow of said fluid inside the pipeline;
letting gas out of the pipeline through the outlet to separate said gas from said liquid to produce separated gas and separated liquid;
compressing said separated gas; and
combining the separated liquid and the compressed gas.

89. The method as claimed in claim 88, wherein the step of compressing said separated gas is performed at the seabed.

90. The method as claimed in claim 88, wherein the step of combining is performed in a compression station.
